(19) United States
(12) Patent Application Publication
(10) Pub. No.: US 2018/0204223 A1
(43) Pub. Date: Jul. 19, 2018

(54) DETERMINING AUDIENCE INTEREST LEVELS DURING PRESENTATIONS BASED ON USER DEVICE ACTIVITY

(71) Applicant: INTERNATIONAL BUSINESS MACHINES CORPORATION, Armonk, NY (US)

(72) Inventors: Gregory J. Boss, Saginaw, MI (US); Andrea Macias Garcia, Escazu (CR); Stephen J. McConnell, Millisle (IE); Piotr Pierga, Palatine, IL (US); Stacey C. Ramos, Dallas, TX (US); Diego Xirinachs Jimenez, Heredia (CR)

(21) Appl. No.: 15/405,944

(22) Filed: Jan. 13, 2017

(51) Int. Cl. G06Q 30/02; H04L 12/26; H04L 29/08; G06Q 10/10

(52) U.S. Cl. CPC G06Q 30/0201; H04L 43/065; H04L 67/10; G06Q 10/1093; H04L 67/02

(57) ABSTRACT

A computer-implemented method includes: receiving, by a computing device, network communications information for a plurality of user devices during a presentation; determining, by the computing device, user device activity for each of the plurality of user devices based on the network communications information; determining, by the computing device, a respective audience interest score for each of the plurality of user devices based on the user device activity; generating, by the computing device, a report representing the audience interest scores; and displaying, by the computing device, the report.

### BACKGROUND

The present invention generally relates to determining audience interest levels during presentations and, more particularly, to determining audience interest levels during presentations based on user device activity.

Delivering a presentation to a large group is a difficult art to master, and a presenter can find it difficult to focus on delivering the presentation while also attempting to “read” the audience to ensure that the presenter maintains audience attention and makes the presentation effective and a memorable experience. For example, while speaking, the presenter may not notice if audience members start looking away, typing on their phones or tablets, leaving the room, etc. Further, if audience members use their user devices, it can be impossible for the presenter to determine whether audience members are using their user devices to access or engage in activities related to relevant or non-relevant content associated with the subject of the presentation.

### SUMMARY

In an aspect of the invention, a computer-implemented method includes: receiving, by a computing device, network communications information for a plurality of user devices during a presentation; determining, by the computing device, user device activity for each of the plurality of user devices based on the network communications information; determining, by the computing device, a respective audience interest score for each of the plurality of user devices based on the user device activity; generating, by the computing device, a report representing the audience interest scores; and displaying, by the computing device, the report.

In an aspect of the invention, there is a computer program product for determining audience interest levels during a presentation. The computer program product includes a computer readable storage medium having program instructions embodied therewith, the program instructions executable by a computing device to cause the computing device to: receive, from a network device hosting a local area network (LAN), user device traffic information for a plurality of user devices connected to the LAN during the presentation; determine user device activity for each of the plurality of user devices based on the user device traffic information; determine a correlation between the user device activity and content of the presentation; generate audience interest scores representing the correlation; generate a report representing the audience interest scores; and display the report.

In an aspect of the invention, there is a system comprising: a CPU, a computer readable memory and a computer readable storage medium associated with a computing device; program instructions to receive criteria for scoring audience interest levels of a presentation based on user device activity; program instructions to obtain, during a presentation, user device activity information for a plurality of user devices; program instructions to determine user device activity for the plurality of user devices based on the user device activity information; program instructions to compare the user device activity with the criteria; program instructions to generate audience interest scores based on the comparing; program instructions to generate a report representing the audience interest scores; and program instructions to display the report. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention

FIG. 5 shows an example environment in accordance with aspects of the present invention.

FIG. 6 shows a block diagram of example components of an audience interest determination server in accordance with aspects of the present invention.

FIG. 7 shows an example flowchart for determining and reporting audience interest levels based on user device network communications in accordance with aspects of the present invention.

FIG. 8 shows an example implementation of an audience interest score report in accordance with aspects of the present invention.

### DETAILED DESCRIPTION

The present invention generally relates to determining audience interest levels during presentations and, more particularly, to determining audience interest levels during presentations based on user device activity. Aspects of the present invention may include a system and/or method to obtain user device activity information during a presentation and use the user device activity information to determine audience interest level. More specifically, aspects of the present invention may determine whether the user device activity is relevant to the subject of a presentation. Reports may be provided to the presenter (e.g., in real-time and/or after the conclusion of a presentation) indicating an overall audience interest level at various times during the presentation. The overall audience interest level may be based on an aggregation of individual audience interest levels for each audience member. As an illustrative example, an audience member's interest level may be determined to be relatively low when the audience member is using their user device to access a game, web page, application, etc., that is not relevant to the subject matter of a presentation. In this way, it is possible for audience interest levels during presentations to be accurately measured based on user device activity, which would not be possible based on human observation.

As described herein, user device activity information may be obtained from network communications information obtained through a network device (e.g., a router, or the like) hosting a local area network (LAN) through which user devices may connect. For example, the network device may host a LAN in a location of a presentation such that user devices that connect to the LAN are identified as those user devices whose users are present during the presentation. Destination web addresses and/or other information indicating user activity may be extracted from network communications information associated with the user devices. As described herein, network communications information may include logs recorded by the network device during the time of the presentation. Additionally, or alternatively, network communications information may include network traffic information obtained by a packet sniffer implemented within the LAN. From the network logs and network communications information, user device activity may be determined (e.g., based on the content of web pages accessed by the user devices, based on known content associated with universe resource locators (URLs) identified in the network logs, etc.). The identified content from user device activity may be compared with content associated with the presentation. Scores may be generated that represent a correlation between the user device activity and the content associated with the presentation. Relatively higher correlation indicates a relatively higher user interest. Scores associated with different user device may be aggregated to generate an overall audience interest level. Further, the audience interest level may be reported in real-time and/or at the end of the presentation to aid a presenter in identifying areas of improvement in a presentation.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

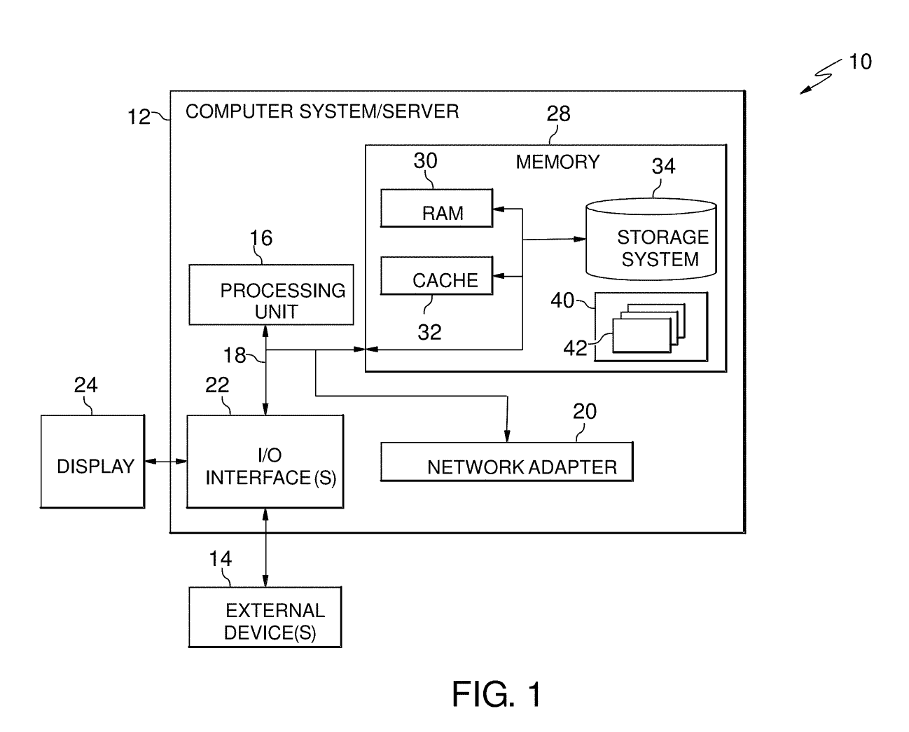

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

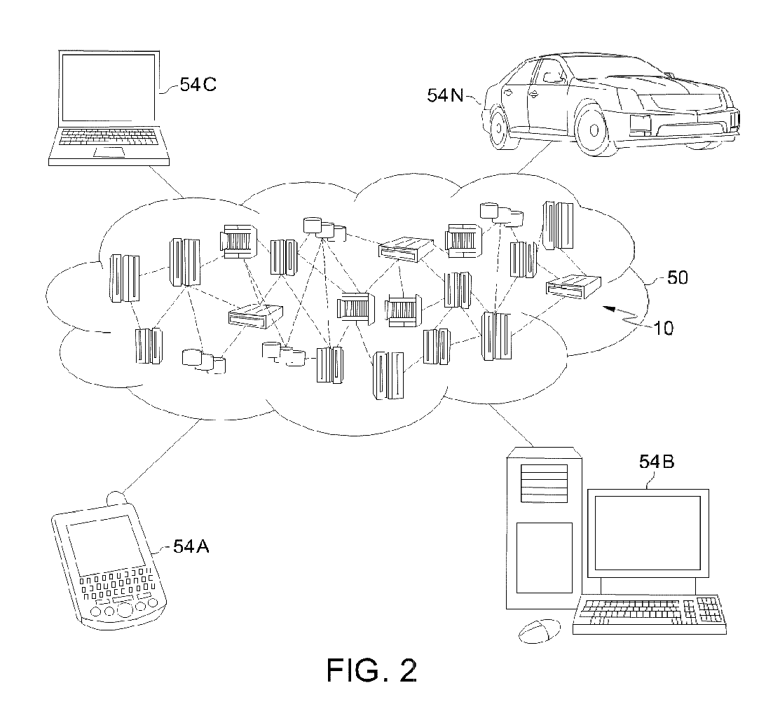

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

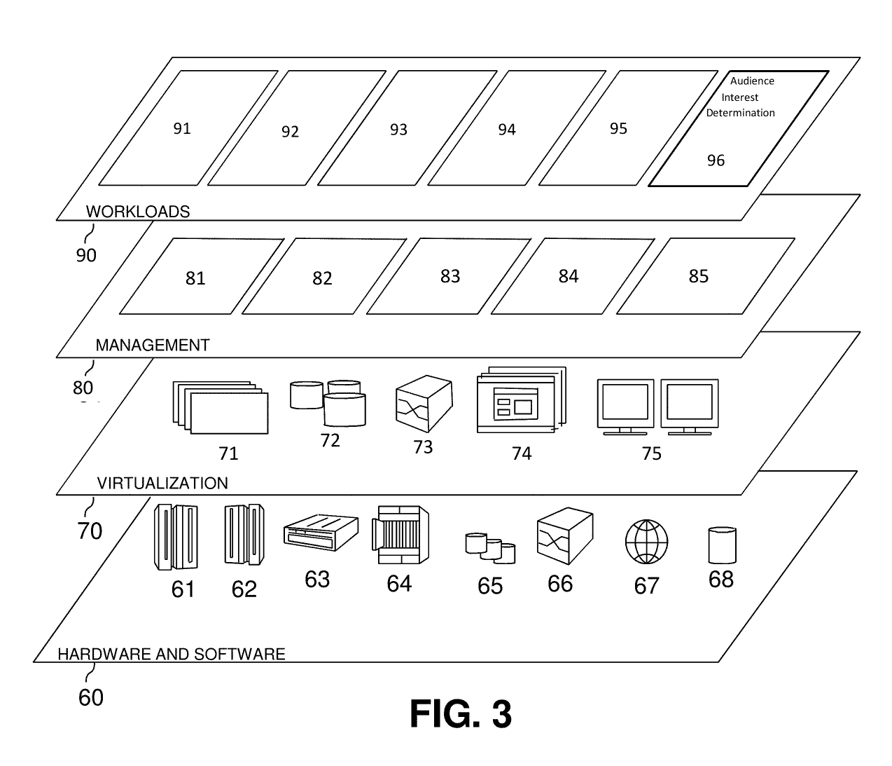

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and audience interest determination 96.

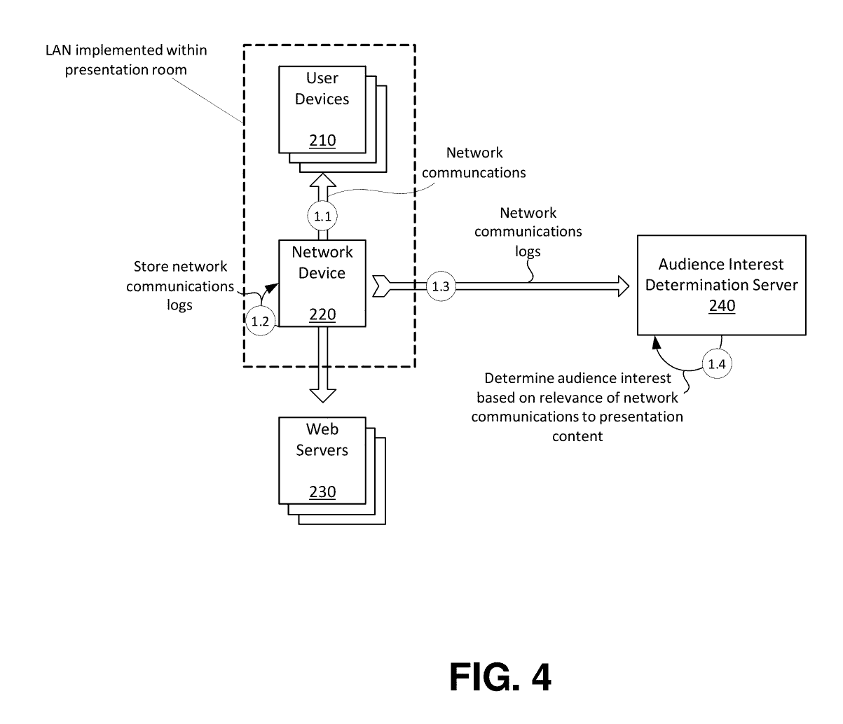

Referring back to FIG. 1, the program/utility 40 may include one or more program modules 42 that generally carry out the functions and/or methodologies of embodiments of the invention as described herein (e.g., such as the functionality provided by audience interest determination 96). Specifically, the program modules 42 may receive user device activity information, determine content from the user device information, determine audience interest scores, aggregate the audience interest scores, and report the aggregated audience interest scores. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of an audience interest determination server 240 as shown in FIG. 4.

FIG. 4 shows an overview of an example implementation in accordance with aspects of the present invention. As shown in FIG. 1, a network device 220 may host a LAN accessible within an area in which a presentation is taking place (e.g., a presentation room). For example, the network device 220 may host a wireless LAN (WLAN) having a communications range corresponding to the presentation room, and the user devices 210 may join the WLAN. Additionally, or alternatively, the network device 220 may host a wired LAN in which one or more user devices 210 may physically connect to the LAN associated with the presentation room.

When joining the LAN, a user device 210 may be prompted to accept terms and conditions that permit the network device 220 to monitor and store network communications information (e.g., activity/browsing information) of the user device 210 and provide the network communications information to an audience interest determination server 240 for performing audience interest analysis. Once joined to the LAN and during normal usage of the user devices 210 by respective users, the user devices 210 may access content on web servers 230 via the network device 220 (at step 1.1). The network communications between the user devices 210 and the web servers 230 may be stored in a network communications log by the network device 220 (at step 1.2). As is understood by those of ordinary skill in the art, the network communications logs may identify URLs accessed and/or other network communications activity/network traffic of each user device 210. For example, the network communications log may store records that each identify a user device 210, a URL accessed by the user device 210, a timestamp when the URL was accessed, and/or other network traffic activity.

At step 1.3, an audience interest determination server 240 may obtain the network communications logs from the network device 220. In embodiments, the network device 220 may include a physical and/or virtual device (e.g., a packet sniffer) implemented in the LAN that may monitor transmitted packets in real time. The audience interest determination server 240 may also obtain network communications information from the packet sniffer or similar device (e.g., in addition to or instead of from network logs). At step 1.4, the audience interest determination server 240 may determine audience interest levels based on a relevance of the network communications to the content of the presentation. For example, for each user device 210 for which a network communications log exists, the audience interest determination server 240 may identify user device activity and/or content associated with the user device activity. As an example, the audience interest determination server 240 may identify that a user device 210 accessed content associated with a particular URL during a time of the presentation. Further, the audience interest determination server 240 may identify the content associated with the URL (e.g., by navigating to the URL, analyzing words, images, etc. referenced by the URL, or web servers 230 associated with the URL).

The audience interest determination server 240 may compare the content of user device activity with predetermined or predefined content of the presentation (e.g., as defined by a presenter or administrator of the presentation). As an illustrative example, assume that the content of the presentation relates to the subject of intellectual property law. Further, assume that the content of the user activity for a user device 210 (e.g., as identified based on the network communications information, such as logs, sniffed packets, user activity data from a user device agent, etc.) is for a gaming application (e.g., when the network communications information indicate communications between the user device 210 and a web server 230 associated with a gaming host). Given the above assumptions, the audience interest determination server 240 may determine a relatively low audience interest level for that user device 210. For a different user device 210, the audience interest determination server 240 may determine a different audience interest level (e.g., based on the user activity information derived from the network logs for the other user device 210). As described herein, the audience interest determination server 240 may aggregate audience interest levels for multiple user devices 210 to generate an aggregated audience score. As described herein, the audience interest determination server 240 may report the audience interest score to a user device 210 of the presenter in real-time (e.g., in the form of a graph). Additionally, or alternatively, the audience interest determination server 240 may report the audience interest score after the conclusion of the presentation.

In embodiments, a presenter or administrator may provide keywords and/or other information for the presentation content with which to compare against the user activity (e.g., for determining a relevance or correlation between the presentation content and the user activity content). Additionally, or alternatively, the audience interest determination server 240 may itself determine the presentation content based on text/image analysis of text and/or images contained in the presentation. Since different presentations are directed to different subjects, different types of user activity/network communications may be deemed favorable or unfavorable. Thus, the content of the presentation is compared to the content of the users' activity (e.g., as determined by network communications information) in order to determine whether the users' activity is considered favorable or unfavorable in terms of interest level.

While in FIG. 4, only the user devices 210 are shown to be part of the LAN implemented by the network device 220, in embodiments, the one or more of the web servers 230 and/or the audience interest determination server 240 may also be a part of the LAN, or may be external to the LAN.

In embodiments, measures may be implemented to prevent user devices 210 located outside of a presentation room from joining a wireless LAN implemented by the network device 220 (e.g., to prevent data “contamination” in which network activity from user devices 210 outside the presentation room may erroneously be considered when generating audience interest levels). For example, network communications information associated with user devices 210 having a relatively weak connection signal with the network device 220 may be discarded from the audience interest level determination process (e.g., as weak connection signals between a user device 210 and the network device 220 may indicate that the user device 210 was located relatively far away from the network device 220 and thus not located in the presentation room). Specifically, the distance between a wireless network device 220 and a user device 210 may determined based on a connection signal strength between the user device 210 and the wireless network device 220, and based on this distance, a determination may be made as to whether the user device is located within a presentation room. Additionally, or alternatively, the audience interest determination server 240 may provide a prompt to the user devices 210 when a presentation is set to begin, and the users may respond to the prompt to confirm that they are viewing the presentation. Additionally, or alternatively, an administrator may select to only consider network activity from wired LAN connections in generating the audience interest levels.

As described herein, user device activity may be determined using other techniques other than from network communication logs stored by the network device 220. For example, an agent application may be implanted on a user device 210 to monitor and/or track user device activity and may provide user device activity information to the audience interest determination server 240. Based on the user device activity received from the agent application, the audience interest determination server 240 may determine the audience interest levels. In this way, the audience interest levels may be determined without the need for the user devices 210 to be a part of a LAN hosted by the network device 220. Also, the agent application may capture keystrokes, typed words, and/or other information that may become encrypted over a LAN. As such, use of the agent application may provide more rich data for determining user activity in relation to data obtained from network communications activity through the LAN since only unencrypted network communications activity may be obtained from network communications activity through the LAN (e.g., destination IP address and/or other information in packet headers).

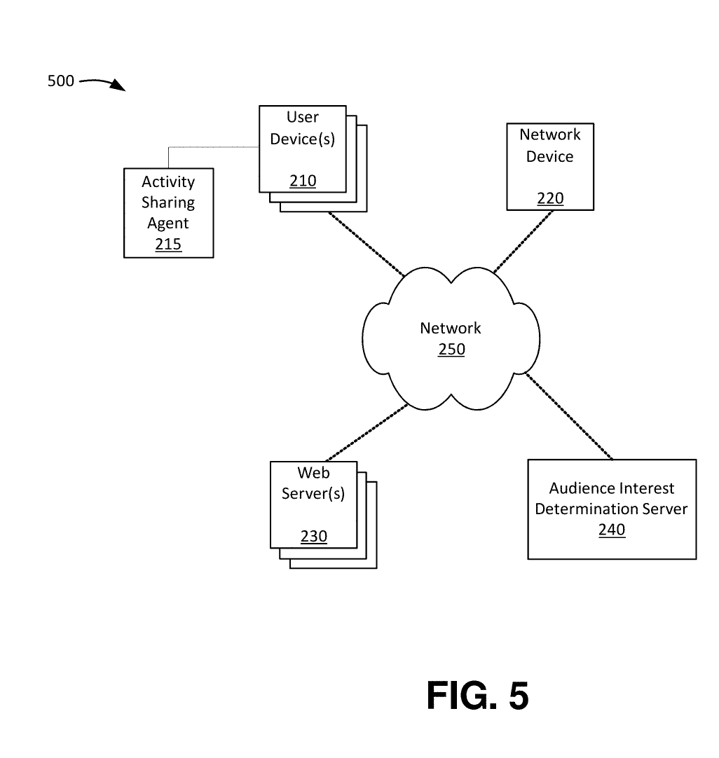

FIG. 5 shows an example environment in accordance with aspects of the present invention. As shown in FIG. 5, environment 500 may include user device(s) 210, network device 220, web server(s) 230, audience interest determination server 240, and network 250. In embodiments, one or more components in environment 500 may correspond to one or more components in the cloud computing environment of FIG. 2. In embodiments, one or more components in environment 500 may include the components of computer system/server 12 of FIG. 1.

The user device(s) 210 may include a computing device capable of communicating via a network, such as the network 250. For example, the user device(s) 210 may correspond to a mobile communication device (e.g., a smart phone or a personal digital assistant (PDA)), a portable computer device (e.g., a laptop or a tablet computer), a desktop computer, and/or another type of computing device. In some embodiments, the user device 210 may join a LAN hosted by the network device 220 in order to access the web servers 230 via the network 250. In embodiments, a user device 210 may include an activity sharing agent 215 that monitors and provides user device activity information and/or network communications information to audience interest determination server 240 in order for audience interest determination server 240 to determine an audience interest level.

The network device 220 may include a device that hosts a network, such as a LAN, WLAN, or the like. In embodiments, the network device 220 may include a router, a switch, a hub, etc. In embodiments, the network device 220 may be placed in a location such that a wireless communications range of the network device 220 corresponds to a presentation room. Additionally, or alternatively, the network device 220 may provide wired connectivity to the LAN. The network device 220 may log network communications of user devices 210 connected to the LAN. In embodiments, the network device 220 may include a physical and/or virtual device (e.g., a packet sniffer) implemented in the LAN that may monitor transmitted packets in real time and may provide information regarding the transmitted packets to the audience interest determination server 240.

The web server(s) 230 may include one or more computing devices (e.g., server devices) that host content that user devices 210 may access (e.g., via the LAN hosted by the network device 220). For example, the web server(s) 230 may correspond to content hosts, application servers, gaming servers, social media servers, etc.

The audience interest determination server 240 may include one or more computing devices that obtain network communication information (e.g., communications logs, information regarding monitored packets from a packet sniffer, etc.) from the network device 220 and analyze the network communication information to determine audience interest levels during a period of time (e.g., a period of time corresponding to a presentation). Additionally, or alternatively, the audience interest determination server 240 may obtain network communications information from the activity sharing agent 215. More specifically, the audience interest determination server 240 may analyze the network communications information to identify content that user devices 210 access when connected to a particular LAN during a particular period of time. As an example, the audience interest determination server 240 may analyze logs for a LAN associated with a particular presentation room during a time when a presentation is scheduled. For example, prior to the beginning of a presentation, a user, administrator, or presenter may instruct the audience interest determination server 240 (e.g., via a user interface of the audience interest determination server 240) to begin analyzing network communication logs for a LAN associated with a presentation room in which the presentation is taking place. Additionally, or alternatively, the audience interest determination server 240 may begin analyzing network communication logs for a LAN associated with a presentation room in which the presentation is scheduled to take place (e.g., based on calendar and/or scheduling information). As described herein, the audience interest determination server 240 may generate audience interest scores, and report the audience interest scores to administrator, user, or presenter in real-time and/or at the conclusion of a presentation. As described herein, the audience interest scores may be presented in a report identifying the interest levels of users at various times in the presentation (e.g., at various time indexes or at various slides in the presentation, etc.).

The network 250 may include network nodes, such as network nodes 10 of FIG. 2. Additionally, or alternatively, the network 250 may include one or more wired and/or wireless networks. For example, the network 250 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 250 may include a LAN, a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 500 is not limited to what is shown in FIG. 5. In practice, the environment 500 may include additional devices and/or networks; fewer devices and/or networks; different devices and/or networks; or differently arranged devices and/or networks than illustrated in FIG. 5. Also, in some implementations, one or more of the devices of the environment 500 may perform one or more functions described as being performed by another one or more of the devices of the environment 500. Devices of the environment 500 may interconnect via wired connections, wireless connections, or a combination of wired and wireless connections.

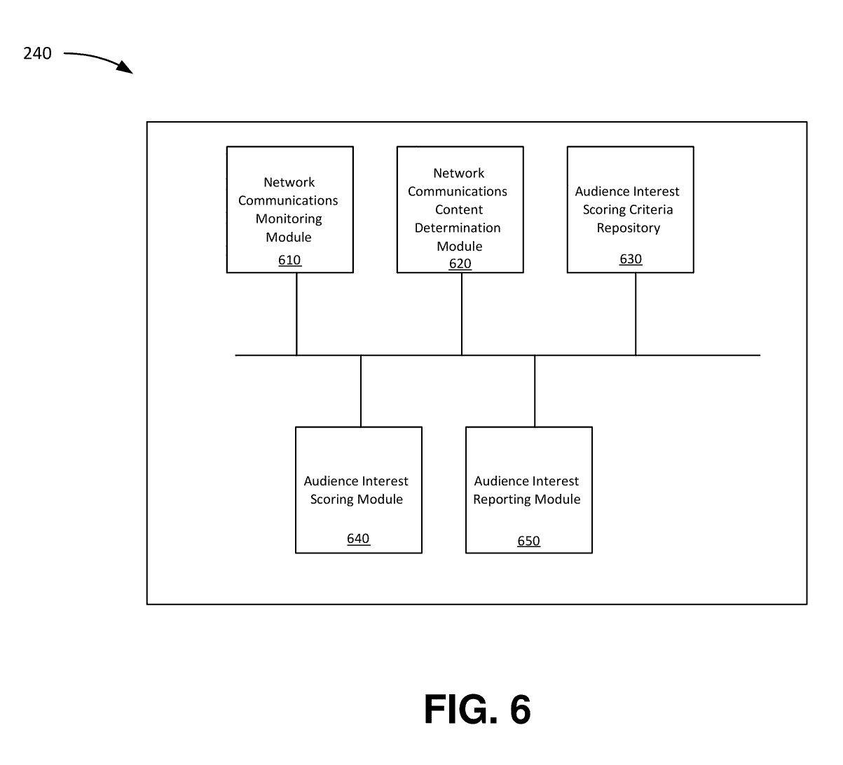

FIG. 6 shows a block diagram of example components of an audience interest determination server 240 in accordance with aspects of the present invention. As shown in FIG. 6, the audience interest determination server 240 may include a network communications monitoring module 610, a network communications content determination module 620, an audience interest scoring criteria repository 630, an audience interest scoring module 640, and an audience interest reporting module 650. In embodiments, the audience interest determination server 240 may include additional or fewer components than those shown in FIG. 6. In embodiments, separate components may be integrated into a single computing component or module. Additionally, or alternatively, a single component may be implemented as multiple computing components or modules.

The network communications monitoring module 610 may include a program module (e.g., program module 42 of FIG. 1) that monitors network communications of user devices 210 that communicate via a LAN hosted by the network device 220 (e.g., by obtaining network communications logs and/or other packet transmission information from the network device 220 during a presentation). Additionally, or alternatively, the network communications monitoring module 610 may obtain network communications information for a user device 210 from an activity sharing agent 215 of the user device 210. As described herein, the network communications monitoring module 610 may begin obtaining network communications logs based on receiving an indication from a user, administrator, and/or presenter that a presentation is beginning. Additionally, or alternatively, the network communications monitoring module 610 may begin obtaining network communications logs based on scheduling information indicating a start time for a scheduled presentation. As is understood by those of ordinary skill in the art, the network communications logs may identify URLs accessed and/or other network communications activity by each user device 210. For example, the network communications log may store records that each identify a user device 210 (e.g., a media access control (MAC) address of the user device 210), a URL accessed by the user device 210, a timestamp when the URL was accessed, a connection signal strength between the network device 220 and the user device 210, etc. Additionally, or alternatively, the network communications logs may identify user inputs to web pages and/or applications, such as comments made on social media web pages/applications, blog posts, etc.

In embodiments, the network communications monitoring module 610 may discard certain logs and/or network communications information from being considered when generating audience interest scores. For example, the network communications monitoring module 610 may discard logs associated with user devices 210 whose signal strength does not satisfy a threshold (e.g., indicating that those user devices 210 were not present in a presentation room during a presentation). Additionally, or alternatively, the network communications monitoring module 610 may discard logs from user devices 210 that were connected to network device 220 wirelessly such that only wired connections are considered (e.g., to reduce the chances that logs from user devices 210 that were not present in the presentation room from being erroneously considered).

The network communications content determination module 620 may include a program module (e.g., program module 42 of FIG. 1) that determines the content associated with the network communications of user devices 210. For example, the network communications content determination module 620 may identify the content associated with a URL in a network communications log (e.g., by navigating to the URL, analyzing words, images, etc. referenced by the URL, web servers 230 associated with the URL, etc.). As an example, the network communications content determination module 620 may identify that the content for network communications associated with one user device 210 is that of a gaming application (e.g., when the network communications log indicates communication between the user device 210 and a gaming server). As another example, the network communications content determination module 620 may identify that the content for network communications associated a different user device 210 is that of an article relating to the subject of intellectual property (e.g., based on accessing a URL in the log and analyzing the text/content in a web page referenced by the URL).

The audience interest scoring criteria repository 630 may include a data storage device (e.g., program module 42 of FIG. 1) that stores criteria for which audience interest is scored. For example, the audience interest scoring criteria repository 630 may store information identifying the subject of a presentation as defined by a user, administrator, and/or presenter. Additionally, or alternatively, the audience interest scoring criteria repository 630 may store information identifying the subject of a presentation as determined based on context analysis of a presentation (e.g., a presentation uploaded by the user, administer, and/or presenter, or referenced by a link). The audience interest scoring criteria repository 630 may store keywords, subjects, applications, actions, and/or other information for the presentation content with which to compare against the network communications content associated with user devices 210. For example, since different presentations are directed to different subjects, different types of user activity/network communications may be deemed favorable or unfavorable.

In embodiments, the audience interest scoring criteria repository 630 may store weightings and/or value information to specify how different user activities are scored and their values. For example, certain user activity/network communications may be valued positively, whereas other user activity/network communications may be valued negatively. Also, certain activity/network communications may be weighted more heavily than others.

The audience interest scoring module 640 may include a program module (e.g., program module 42 of FIG. 1) that generates a respective score for each user device 210 whose network communications information is obtained and is being considered (e.g., those user devices 210 that are part of the LAN hosted by the network device 220 and whose network communications information was not previously discarded). As described herein, the audience interest scoring module 640 may generate an audience interest score based on comparing the network communications content determined by the network communications content determination module 620 with the presentation content as stored by the audience interest scoring criteria repository 630. Additionally, or alternatively, the audience interest scoring module 640 may generate an audience interest score based on scoring criteria stored by the audience interest scoring criteria repository 630 (e.g., by scoring certain content/activity either positively or negatively by a particular value and/or weight). As described herein, the audience interest scoring module 640 may generate audience interest scores at configurable time intervals (e.g., an interest score over a one-minute period, two-minute period, etc.). Additionally, or alternatively, the audience interest scoring module 640 may generate audience interest scores for each user device 210, and may aggregate multiple audience interest scores to generate an aggregated audience interest score identifying an overall audience interest level. In embodiments, the audience interest scores may be values on a scale (e.g., a scale from 0-100 or some other scale).

The audience interest reporting module 650 may include a program module (e.g., program module 42 of FIG. 1) that reports audience interest scores (e.g., to a user device 210 of a presenter and/or administrator). In embodiments, the audience interest reporting module 650 may generate a report identifying the audience interest levels. In embodiments, the report may be in the form of a graph (e.g., a line graph, scatter plot, bar graph, or the like) in which the audience interest score is plotted in relation to time. The audience interest reporting module 650 may report individual audience interest scores of individual user devices 210. Additionally, or alternatively, the audience interest reporting module 650 may report aggregated audience interest scores of a group of user devices 210. The audience interest reporting module 650 may report audience interest scores in real-time and/or at another time (e.g., the conclusion of the presentation). In this way, a presenter may better identify areas of improvement for improving audience interest.

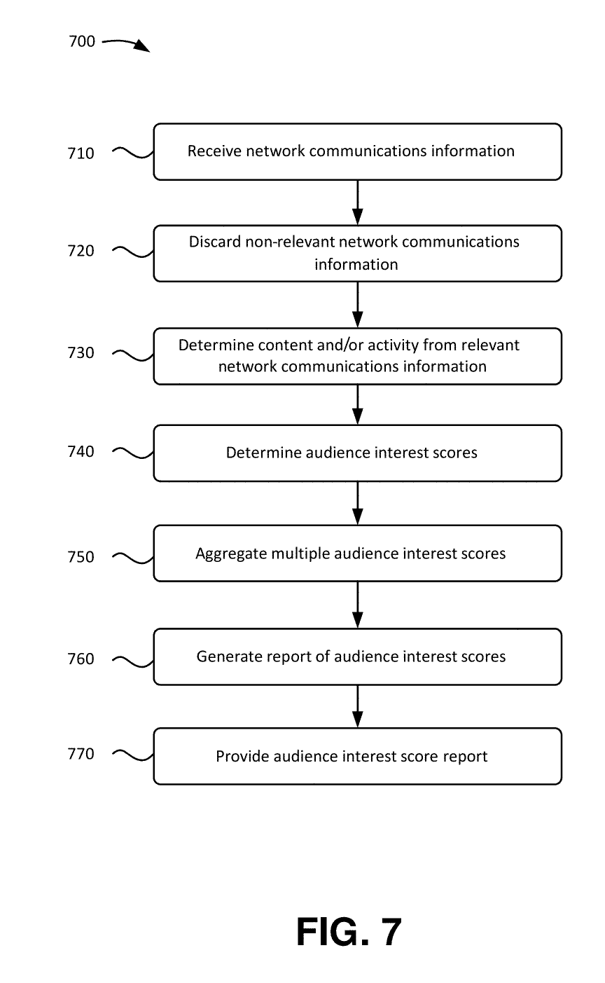

FIG. 7 shows an example flowchart of an example process 700 for determining and reporting audience interest levels based on user device network communications. The steps of FIG. 7 may be implemented in the environment of FIG. 5, for example, and are described using reference numbers of elements depicted in FIG. 5. As noted above, the flowchart illustrates the architecture, functionality, and operation of possible implementations of systems, methods, and computer program products according to various embodiments of the present invention.

As shown in FIG. 7, process 700 may include receiving network communications information (step 710). For example, as described above with respect to the network communications monitoring module 610, the audience interest determination server 240 may obtain and/or receive network communications information (e.g., network communications logs and/or network traffic information) from the network device 220. Additionally, or alternatively, the audience interest determination server 240 may obtain network communications information for a user device 210 from an activity sharing agent 215 of the user device 210. As described herein, the audience interest determination server 240 may begin receiving network communications information based on receiving an indication from a user, administrator, and/or presenter that a presentation is beginning. Additionally, or alternatively, the audience interest determination server 240 may begin obtaining network communications information based on scheduling information indicating a start time for a scheduled presentation. The network communications information may include logs identifying URLs accessed and/or other network communications activity by each user device 210. For example, the network communications log may store records that each identify a user device 210, a URL accessed by the user device 210, a timestamp when the URL was accessed, a connection signal strength between the network device 220 and the user device 210, etc. As described herein, the network communications information may represent user device activity (e.g., activity occurring on user devices 210).

Process 700 may further include discarding non-relevant network communications information (step 720). For example, the audience interest determination server 240 may analyze the network communications information and may discard certain logs from consideration of audience interest scores. As described herein, the audience interest determination server 240 may discard logs associated with user devices 210 whose signal strength does not satisfy a threshold (e.g., indicating that those user devices 210 were not present in a presentation room during a presentation). Additionally, or alternatively, the audience interest determination server 240 may discard logs from user devices 210 that were connected to network device 220 wirelessly such that only wired connections are considered (e.g., to reduce the chances that logs from user devices 210 that were not present in the presentation room from being erroneously considered).

Process 700 may also include determining content and/or activity from the relevant network communications information (step 730). For example, as described above with respect to the network communications content determination module 620, the audience interest determination server 240 may identify the content from the remaining relevant logs. As an example, the audience interest determination server 240 may identify the content associated with a URL in a network communications log for a user device 210 (e.g., by navigating to the URL, analyzing words, images, etc. referenced by the URL, web servers 230 associated with the URL, etc.). Additionally, or alternatively, the audience interest determination server 240 may identify the content based on other network communications information that indicates the content and/or user activity (e.g., network activity related to accessing certain applications, web pages, etc.). In embodiments, the audience interest determination server 240 may determine the content and/or network activity for each user device 210 for which network logs are being considered.

Process 700 may further include determining an audience interest score (step 740). For example, as described above with respect to the audience interest scoring module 640, the audience interest determination server 240 may generate respective audience interest scores for each user device 210 whose network communications information is obtained and is being considered (e.g., as described above with respect to steps 710 and 720). As described herein, the audience interest determination server 240 may generate an audience interest score based on comparing the network communications content determined by the network communications content determination module 620 with the presentation content as stored by the audience interest scoring criteria repository 630. Additionally, or alternatively, the audience interest determination server 240 may generate an audience interest score based on scoring criteria stored by the audience interest scoring criteria repository 630 (e.g., by scoring certain content/activity either positively or negatively by a particular value and/or weight). As described herein, the audience interest determination server 240 may generate audience interest scores at configurable time intervals (e.g., an interest score over a one-minute period, two-minute period, etc.). Additionally, or alternatively, the audience interest determination server 240 may generate audience interest scores for each user device 210, and may aggregate multiple audience interest scores to generate an aggregated audience interest score identifying an overall audience interest level. In embodiments, the audience interest scores may be values on a scale (e.g., a scale from 0-100 or some other scale). As described herein, the audience interest scores may represent a correlation between user device activity (as determined from the network communications information) and content of the presentation.

Process 700 may further include aggregating multiple audience interest scores (step 750). For example, as described above with respect to the audience interest reporting module 650, the audience interest determination server 240 may aggregate audience interest scores associated with individual user devices 210 in a group. In embodiments, the audience interest determination server 240 may aggregate the scores by averaging the scores. In embodiments, the audience interest determination server 240 may weigh scores from particular user devices 210 more heavily/lighter than others.

Process 700 may also include generating a report of the audience interest scores (step 760). For example, as described above with respect to the audience interest reporting module 650, the audience interest determination server 240 may generate a report that indicates the audience interest scores at different periods of time. In embodiments, the report may be in the form of a graph (e.g., a line graph, scatter plot, bar graph, or the like) in which the audience interest score is plotted in relation to time. The audience interest determination server 240 may report individual audience interest scores of individual user devices 210. Additionally, or alternatively, the audience interest determination server 240 may report aggregated audience interest scores of a group of user devices 210.

Process 700 may further include providing the audience interest score report (step 770). For example, as described above with respect to the audience interest reporting module 650, the audience interest determination server 240 may provide the audience interest score report. In embodiments, the audience interest determination server 240 may provide the audience interest score report by displaying, printing, and/or saving the audience interest score report. Additionally, or alternatively, the audience interest determination server 240 may provide the audience interest score report to another device for display. In embodiments, the audience interest determination server 240 may report audience interest scores in real-time and/or at another time (e.g., the conclusion of the presentation). In this way, a presenter may better identify areas of improvement for improving audience interest.

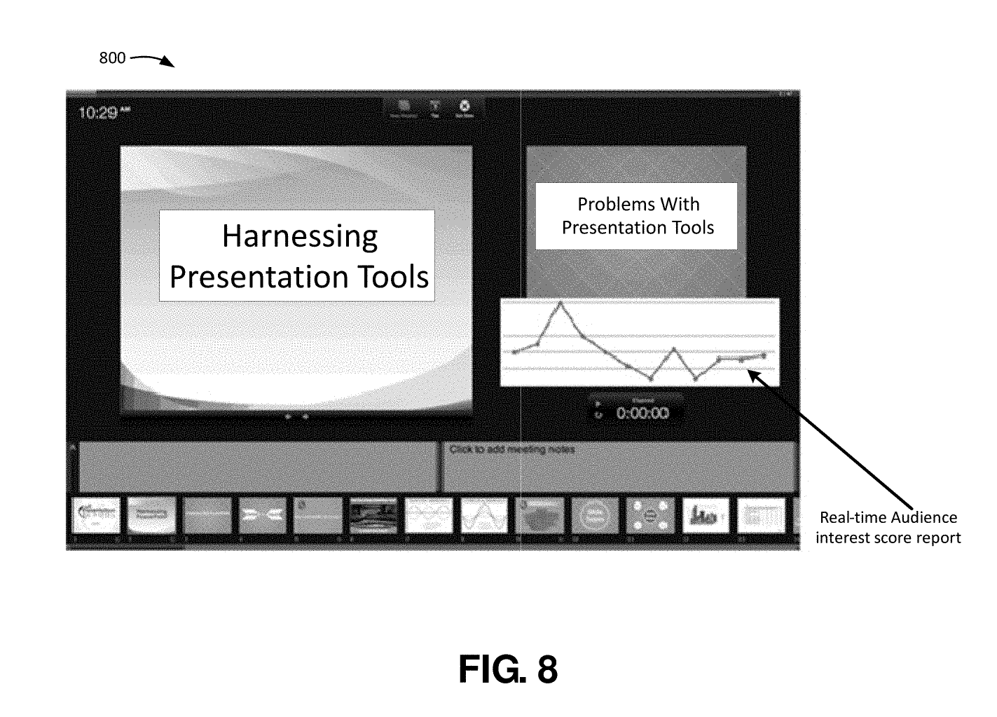

FIG. 8 shows an example implementation of an audience interest score report in accordance with aspects of the present invention. Interface 800 of FIG. 8 shows an example presentation with an example audience interest score report provided in real-time. In embodiments, the audience interest score report may be presented on a display screen viewable to the presenter only rather than a display screen viewable to the audience (e.g., to provide the presenter with feedback of audience interest during the presentation). As shown in FIG. 8, the audience interest score report may be in the form of a line graph, although in practice, the audience interest score report may be in a different form. Also, the audience interest score report may be provided after the conclusion of the presentation rather than in real time. Additionally, or alternatively, the audience interest score report may identify an aggregation of individual audience interest scores from individual user devices 210, or may identify audience interest scores on a device-by-device basis.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computing device, network communications information for a plurality of user devices during a presentation;
determining, by the computing device, user device activity for each of the plurality of user devices based on the network communications information;
determining, by the computing device, a respective audience interest score for each of the plurality of user devices based on the user device activity;
generating, by the computing device, a report representing the audience interest scores; and
displaying, by the computing device, the report.

2. The method of claim 1, wherein the network communications are received from a network device connected to the plurality of user devices via a local area network (LAN) hosted by the network device, wherein the a location of the LAN corresponds to a location of the presentation.

3. The method of claim 2, further comprising discarding a subset of the network communications information based on connection signal strength information between each of the plurality of user devices the network device, wherein determining the audience interest score is based on a remaining subset of network communications information.

4. The method of claim 1, wherein the network communications are received from respective agents residing on the plurality of user devices.

5. The method of claim 1, wherein the report represents the audience interest scores in of the form of a line graph.

6. The method of claim 1, wherein the report represents audience interest scores on a device by device basis or an aggregated basis.

7. The method of claim 1, wherein the determining the audience interest scores is based on comparing the user device activity with content of the presentation.

8. The method of claim 1, wherein the determining the user device activity comprises accessing a web page associated with a universal resource locator (URL) identified in by network communications information.

9. The method of claim 1, wherein receiving the network communications information is based on scheduling information defining a start-time for the presentation.

10. The method of claim 1, wherein a service provider at least one of creates, maintains, deploys and supports the computing device.

11. The method of claim 1, wherein the receiving the network communications, the determining the user activity, the determining the respective audience interest score, the generating the report, and the providing the report are provided by a service provider on a subscription, advertising, and/or fee basis.

12. The method of claim 1, wherein the computing device includes software provided as a service in a cloud environment.

13. The method of claim 1, further comprising deploying a system for determining audience interest levels during presentations, comprising providing a computer infrastructure operable to perform the receiving the network communications, the determining the user activity, the determining the respective audience interest score, the generating the report, and the providing the report.

14. A computer program product for determining audience interest levels during a presentation, the computer program product comprising a computer readable storage medium having program instructions embodied therewith, the program instructions executable by a computing device to cause the computing device to:
receive, from a network device hosting a local area network (LAN), user device traffic information for a plurality of user devices connected to the LAN during the presentation;
determine user device activity for each of the plurality of user devices based on the user device traffic information;
determine a correlation between the user device activity and content of the presentation;
generate audience interest scores representing the correlation;
generate a report representing the audience interest scores; and
display the report.

15. The computer program product of claim 14, wherein a location of the LAN corresponds to a location of the presentation.

16. The computer program product of claim 14, wherein the program instructions further cause the computing device to discard a subset of the user device traffic information based on connection signal strength information between each of the plurality of user devices the network device, wherein the determining the correlation is based on a remaining subset of network communications information.

17. The computer program product of claim 14, wherein the report represents the audience interest scores in a line graph.

18. The computer program product of claim 14, wherein the report represents audience interest scores on a device by device basis or an aggregated basis.

19. A system comprising:
a CPU, a computer readable memory and a computer readable storage medium associated with a computing device;
program instructions to receive criteria for scoring audience interest levels of a presentation based on user device activity;
program instructions to obtain, during a presentation, user device activity information for a plurality of user devices;
program instructions to determine user device activity for the plurality of user devices based on the user device activity information;
program instructions to compare the user device activity with the criteria;
program instructions to generate audience interest scores based on the comparing;
program instructions to generate a report representing the audience interest scores; and
program instructions to display the report,
wherein the program instructions are stored on the computer readable storage medium for execution by the CPU via the computer readable memory.

20. The system of claim 19, wherein the user device activity information is received from at least one of:
a network device hosting a local area network (LAN) to which the plurality of user devices communicate; and
respective agents on the plurality of user devices.
